(19) United States
(12) Patent Application Publication
(10) Pub. No.: US 2023/0186876 A1
(43) Pub. Date: Jun. 15, 2023

(54) BEAT SOUND GENERATION TIMING GENERATING DEVICE, BEAT SOUND GENERATION TIMING GENERATING METHOD, AND NON-TRANSITORY COMPUTER READABLE MEDIUM STORING PROGRAM

(71) Applicant: Roland Corporation, Shizuoka (JP)

(72) Inventors: Satoshi KUSAKABE, Shizuoka (JP); Takahiro MURAI, Shizuoka (JP); Junjiro KOMATSU, Shizuoka (JP)

(73) Assignee: Roland Corporation, Shizuoka (JP)

(21) Appl. No.: 17/925,011

(22) PCT Filed: May 21, 2020
(86) PCT No.: PCT/JP2020/020101

§ 371 Date: Nov. 14, 2022

(51) Int. Cl. G10H 1/00; G10H 1/40

(52) U.S. Cl. CPC G10H 1/0008; G10H 1/40; G10H 2210/076; G10H 2210/375

(57) ABSTRACT

An information processing device executes: a process of generating, from inputted data of a musical piece, a plurality of intensity data in a predetermined time interval, each of the plurality of intensity data indicating a timing governing a beat of the musical piece and a power at the timing; a process of calculating a cycle and a phase of the beat of the musical piece by using the plurality of intensity data for each of the time intervals; a process of detecting a generation timing of a beat sound based on the calculated cycle and the calculated phase of the beat of the musical piece; and a process of setting one of a wide range and a narrow range narrower than the wide range as a BPM range to be used for calculation of the cycle and the phase of the beat for each of the time intervals.

### TECHNICAL FIELD

The disclosure relates to a beat sound generation timing generating device, a beat sound generation timing generating method, and a program.

### RELATED ART

Conventionally, there is a technique for generating generation timings of a beat sound from a signal of a musical instrument (see, for example, Patent Document 1).

### RELATED ART DOCUMENTS

### Patent Documents

Patent Document 1: International Publication No. 2019/22490

### SUMMARY OF INVENTION

### Problems to Be Solved by Invention

In a musical piece, although the tempo is substantially constant musically, it is not uncommon for several intrinsic beats to be present at the same time. For example, a musical piece may be cut to quarter notes on the musical score, or may be cut to two-beat triplets. In the related art, in the progression of a musical piece, unstable generation timings of a beat sound are sometimes generated, i.e., detecting beats matching quarter notes in some time intervals, and detecting beats matching two-beat triplets in other time intervals.

It is an objective of the disclosure to provide a beat sound generation timing generating device, a beat sound generation timing generating method, and a program capable of stabilizing generation timings of a beat sound.

### Means for Solving Problems

An aspect of the disclosure is a beat sound generation timing generating device, including a generating part, a calculating part, a detecting part, and a control part. The generating part generates, from inputted data of a musical piece, a plurality of intensity data in a predetermined time interval, each of the plurality of intensity data indicating a timing governing a beat of the musical piece and a power at the timing. The calculating part calculates a cycle and a phase of the beat of the musical piece by using the plurality of intensity data for each of the time intervals. The detecting part detects a generation timing of a beat sound based on the cycle and the phase of the beat of the musical piece. The control part sets one of a wide range and a narrow range narrower than the wide range as a BPM (beats per minute) range to be used for calculation of the cycle and the phase of the beat for each of the time intervals.

An embodiment of the disclosure may be a beat sound generation timing generating method, a program, or a recording medium recording the program, which has the same features as the beat sound generation timing generating device described above.

### BRIEF DESCRIPTION OF DRAWINGS

FIG. 1 shows a configuration example of a beat sound generation timing generating device.

FIG. 2 shows a configuration example of a control part.

FIG. 3 is a flowchart showing a processing example of a generating part.

FIG. 4A shows an example of a digital signal (also referred to as a musical piece signal) of a 12-second musical piece inputted to the generating part, and FIG. 4B shows an example of Spx data generated from the musical piece signal of FIG. 4A.

FIG. 5 is a flowchart showing a processing example of a calculating part.

FIG. 6 is a diagram showing an example of Spx data and a sine wave of a BPM used for Fourier transform.

FIG. 7 illustrates a relationship between a cosine wave representing a BPM and generation timings of the beat.

FIG. 8 is a flowchart showing an example of a detection process of a beat generation timing by a detecting part 104.

FIG. 9A is a diagram showing, by vertical lines, beat positions (generation timings of the beat sound) detected from a signal of a musical piece. FIG. 9B shows the BPM value over time corresponding to the example shown in FIG. 9A.

FIG. 10 shows spectral intensity data at moments of a musical piece.

FIG. 11 is a flowchart showing a processing example showing a first method for setting a BPM range.

FIG. 12 is a table illustrating states of a button.

FIG. 13 is a flowchart showing a processing example showing a second method for setting the BPM range.

FIG. 14 is a flowchart showing a processing example showing a third method for setting the BPM range.

FIG. 15 is a flowchart showing a processing example showing the third method for setting the BPM range.

FIG. 16 shows, by vertical lines, the beats detected in the case where the second and third methods are applied to the signal of the musical piece shown in FIG. 9A.

### DESCRIPTION OF EMBODIMENTS

When keeping the beat to a musical piece being performed or reproduced, there is variety in the beat. The variety means that there is not necessarily only one good way to keep the beat musically. Generally, a musical piece has several intrinsic beats even though the tempo is substantially constant musically. A “good beat” might be a beat that ticks to quarter notes on a musical score. Alternatively, it might be a beat that ticks to two-beat triplets.

Algorithms for beat detection (generation of timings for generating a beat sound) in the related art often detect these beats intermingled in time and output beat-matched sounds (such as handclap sounds). That is, in some time intervals, sounds are outputted matching quarter notes, and in other time intervals, sounds are outputted matching two-beat triplets. When beats are represented by BMP values, these appear as discontinuous values for each time interval.

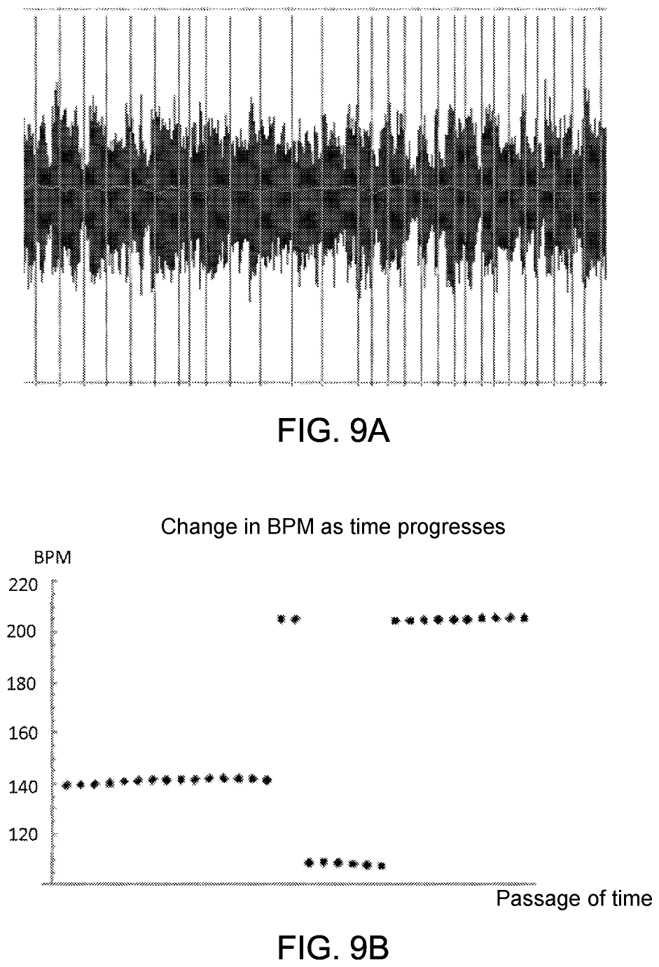

FIG. 9A is a diagram showing, by vertical lines, beat positions (generation timings of the beat sound) detected from a signal of a musical piece. In the example shown in FIG. 9A, the cycle of generation timings of the beat sound intermittently changes during the progression of the musical piece. FIG. 9B shows the BPM value over time corresponding to the example shown in FIG. 9A. Such a phenomenon in which the cycle of generation timings of the beat sound intermittently changes does not occur because the progression of the musical piece changes at each moment. In other words, in a state in which two beats (e.g., a quarter note and a two-beat triplet) always coexist intrinsically in a musical piece, the above phenomenon happens because the algorithm chooses one beat at some moments and chooses the other beat at other moments. However, based on the variety of beats, it cannot be determined that one beat is correct and the other is incorrect.

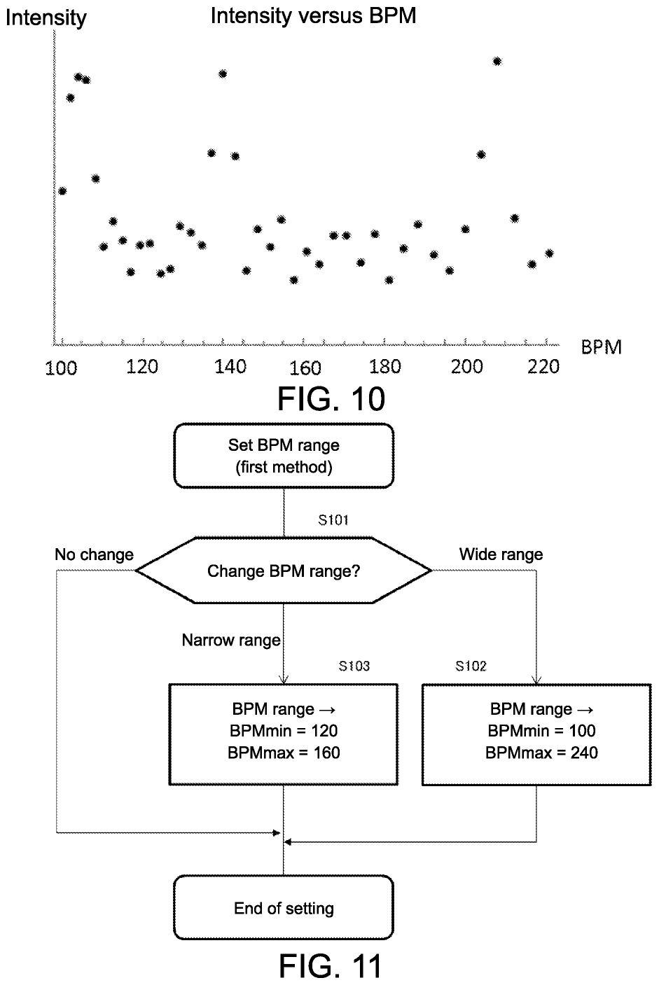

As shown in FIG. 10, spectral intensity data to be considered when selecting multiple intrinsically existing beats has several peaks, and each peak represents presence of an intrinsic beat. In the related art, a maximum peak among multiple peaks is selected as the beat of each moment. As a result, the BPM changes intermittently.

It may not be suitable to emit sounds according to generation timings of the beat sound following intermittent changes in the BPM. For example, if a beat following quarter notes is detected at a moment, it is preferable to continue to constantly detect the beat at quarter notes. A beat sound generation timing generating device (beat detection device) according to the embodiment has been made to solve the problem that unstable generation timings of the beat sound are generated as described above.

The beat sound generation timing generating device according to the embodiment has the following configuration:

(1) a generating part which generates, from inputted data of a musical piece, a plurality of intensity data in a predetermined time interval, each of the plurality of intensity data indicating a timing governing a beat of the musical piece and a power at the timing;

(2) a calculating part which calculates a cycle and a phase of the beat of the musical piece by using the plurality of intensity data for each of the time intervals;

(3) a detecting part which detects a generation timing of a beat sound based on the cycle and the phase of the beat of the musical piece; and

(4) a control part which sets one of a wide range and a narrow range narrower than the wide range as a BPM (beats per minute) range to be used for calculation of the cycle and the phase of the beat for each of the time intervals.

The following configuration may be employed in the beat sound generation timing generating device. That is, the BPM range being the narrow range is a predetermined numerical range centered on a BPM value to be used for calculation of the cycle and the phase of the beat in a current time interval. In this manner, the cycle and the phase of the beat can be calculated with the BPM range centered on the BPM value in the current time interval, and the desired beat can be stably detected.

The following configuration may be employed in the beat sound generation timing generating device. That is, while a setting of selecting the narrow range is maintained, the calculating part performs calculation of the cycle and the phase of the beat for each of the time intervals by using the narrow range. In this manner, the BPM range can be made to follow changes in the beat of the musical piece.

The following configuration may be employed in the beat sound generation timing generating device. That is, while a button for switching the BPM range is long pressed, the control part sets the BPM range to the wide range, and in a case where long press of the button has been released, the control part changes the BPM range to the narrow range. In this manner, switching between the wide range and the narrow range can be performed by using one button.

The following configuration may be employed in the beat sound generation timing generating device. That is, the calculating part determines a BPM for the plurality of intensity data based on the timings indicated by the plurality of intensity data, calculates one cycle of the BPM as the cycle of the beat, and calculates, as the phase of the beat, a relative position of the generation timing of the beat sound in a sine wave representing the BPM. The detecting part obtains a count value indicating the cycle of the beat and the phase of the beat, performs timing of the count value by using a counter which increments for each sample at a sampling rate, and detects, as the generation timing of the beat sound, a timing at which a value of the counter reaches the count value.

The following configuration may be employed in the beat sound generation timing generating device. That is, the calculating part calculates, as the cycle of the beat, one cycle of a BPM of a time when a value of Fourier transform data obtained by Fourier transform performed on each of the plurality of intensity data and each of a plurality of BPMs becomes maximum.

[Embodiments]

Hereinafter, a beat sound generation timing generating device, a beat sound generation timing generating method, and a program according to embodiments will be described with reference to the drawings. The configurations of the embodiments are exemplary. The disclosure is not limited to the configurations of the embodiments.

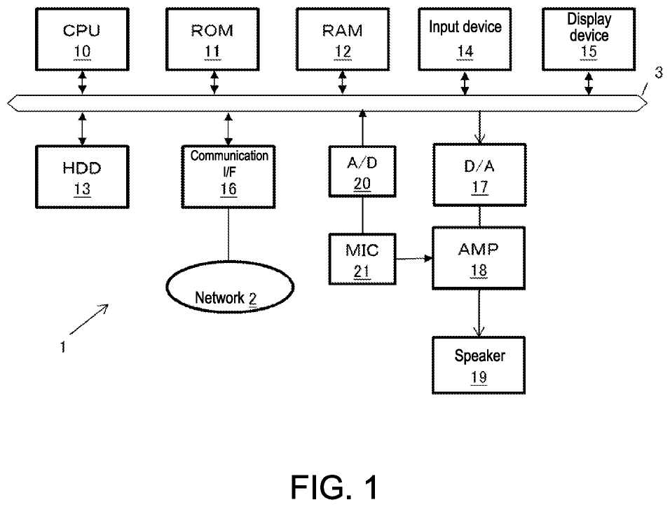

FIG. 1 shows a configuration example of a beat sound generation timing generating device. The beat sound generation timing generating device may be configured as a stand-alone device, or may be incorporated in a karaoke machine or an electronic musical instrument. In FIG. 1, a beat sound generation timing generating device 1 includes a CPU 10, a ROM (read only memory) 11, a RAM (random access memory) 12, a hard disk drive (HDD) 13, an input device 14, a display device 15, and a communication interface (communication I/F) 16, which are connected to a bus 3. The beat sound generation timing generating device 1 further includes a digital-to-analog converter (D/A) 17 and an analog-to-digital converter (A/D) 20, which are connected to the bus 3. An amplifier (AMP) 18 is connected to the D/A 17, and a speaker 19 is connected to the AMP 18. A microphone (MIC) 21 is connected to the A/D 20.

The ROM 11 stores various programs executed by the CPU 10 and data used when executing the programs. The RAM 12 is used as a program expansion area, a work area for the CPU 10, a data storage area, etc. The HDD 13 stores programs, data used when executing the programs, musical piece data, etc. The musical piece data is sound data having a predetermined audio file format such as the MP3 or WAVE format. The audio file format may also be a format other than the MP3 or WAVE format. The ROM 11 and the RAM 12 are examples of a main storage device, and the HDD 13 is an example of an auxiliary storage device. The main storage device and the auxiliary storage device are examples of a storage device or a storage medium.

The input device 14 is a key, a button, a touch panel, a knob, a switch, etc., and is used for input of information (including instructions and commands) or setting of parameters related to generation or reproduction of musical tones. The display device 15 is used for display of information. The communication I/F 16 is connected to a network 2 and governs processes related to communication. The CPU 10 may, for example, download desired musical piece data (musical piece signal) from the network 2 and store them to the HDD 13 according to an instruction inputted from the input device 14.

The CPU 10 performs various processes by executing programs. In addition to the above-described process related to musical piece download, the processes also include a process related to reproduction of a musical piece, a process of generating a beat sound generation timing of a musical piece, a process of outputting a beat sound (e.g., a clap sound, especially a hand clap sound) matching the beat sound generation timing.

For example, when reproducing musical piece data, by executing a program, the CPU 10 generates digital data (digital signal) representing sounds of a musical piece from the musical piece data read from the HDD 13 to the RAM 12, and supplies digital data to the D/A 17. The D/A 17 converts the digital data representing sounds into an analog signal by digital-analog conversion, and outputs the analog signal to the AMP 18. An analog signal with an amplitude adjusted by the AMP 18 is outputted from the speaker 19.

The MIC 21 collects, for example, a singing sound accompanied (karaoke) by the sound of the musical piece outputted from the speaker 19. An analog audio signal collected by the MIC 21 is amplified in amplitude by the AMP 18 and is amplified from the speaker 19. At this time, the singing sound may be mixed with the musical piece sound, or may be respectively outputted from separate speakers.

Further, the MIC 21 is also used when collecting sounds of a performance (so-called live performance) using musical instruments or reproduced sounds of a musical piece emitted from an external device, and expanding the sounds (output from the speaker 19) or recording the sounds. For example, a signal of a performance sound collected by the MIC 21 is converted into a digital signal by the A/D 20 and transferred to the CPU 10. The CPU 10 converts the signal of the performance sound into a format conforming to an audio file format to generate an audio file, and stores the audio file to the HDD 13. A generation process of a beat sound generation timing may be performed on the sound signal of the musical piece collected by the MIC 21.

The beat sound generation timing generating device 1 may include a drive device (not shown) for a disk-type recording medium such as a compact disk (CD). In that case, a digital signal representing the sound of a musical piece read from the disk-type recording medium using the drive device may be supplied to the D/A 17 to reproduce a musical piece sound. In that case, the generation process of a beat sound generation timing may be performed on the sound signal of the musical piece read from the disk-type recording medium.

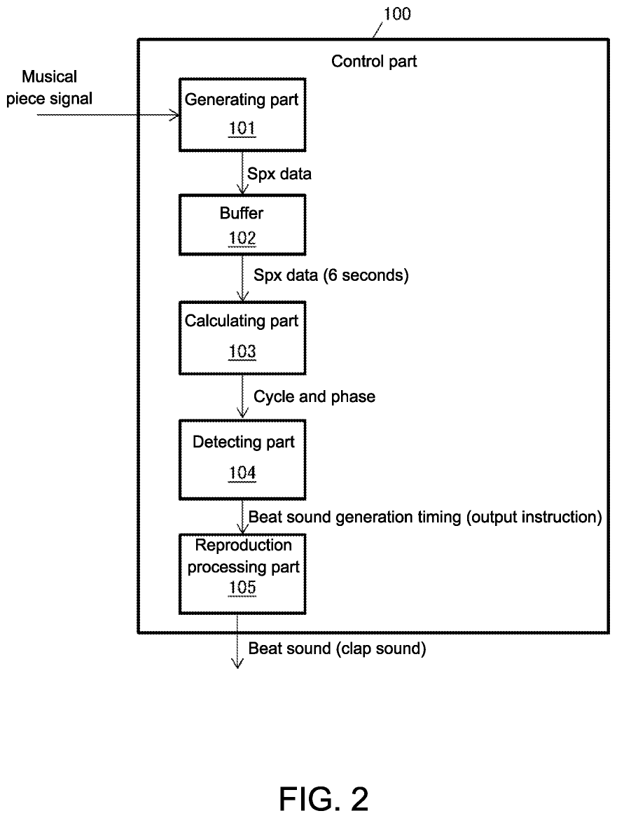

FIG. 2 shows a configuration example of a control part 100. As shown in FIG. 2, by executing programs, the CPU 10 operates as a control part 100 including a generating part 101 of time sparse data (denoted as “Spx data”: equivalent to intensity data), a buffer 102, a calculating part 103 of a cycle data and a phase data, a detecting part 104 of a generation timing of a beat, a reproduction processing part 105 of a beat sound, etc. The buffer 102 is provided in a predetermined storage area of the RAM 12 or the HDD 13, for example.

The generating part 101 of Spx data generates and outputs Spx data by using digital data representing sounds of a musical piece. The buffer 102 accumulates Spx data (corresponding to a plurality of intensity data) of at least a predetermined duration. In this embodiment, 6 seconds is exemplified as the length of the predetermined duration (time interval), but the predetermined duration may be longer or shorter than 6 seconds. The calculating part 103 calculates a cycle data and a phase data of a beat by using a set of Spx data of the predetermined duration accumulated in the buffer 102. The detecting part 104 of a generation timing detects a generation timing of a beat sound by using the cycle data and the phase data. The reproduction processing part 105 performs a reproduction process of a beat sound matching the generation timing.

The details of the process in each part forming the control part 100 will be described below.

<Generation of Spx Data>

The generation of Spx data by the generating part 101 will be described. A digital signal representing a sound of musical piece data (data sent to the D/A 17 for audio output) for reproduction is inputted to the generating part 101. The digital signal (musical piece signal) representing the sound may be obtained by a reproduction process of musical piece data stored in the HDD 13 or by A/D conversion of an audio signal collected by the MIC 20.

The digital data representing the sound is stored in the RAM 12 and used for the process of the generating part 101. The digital data representing the sound is a set of sample data (generally, voltage values of an analog signal) taken from an analog signal according to a predetermined sampling rate. In this embodiment, as an example, it is assumed that the sampling rate is 44100 Hz. However, the sampling rate may be changed as appropriate as long as the desired FFT resolution is obtained.

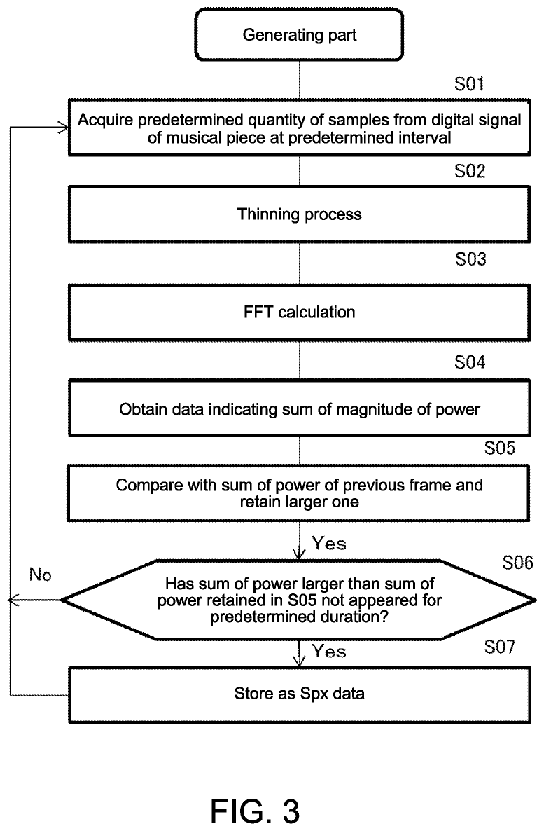

FIG. 3 is a flowchart showing a processing example of the generating part 101. A digital data (digital signal) representing a sound of a musical piece that is sent to the D/A 17 for musical sound output (reproduction) is inputted to the generating part 101. The generating part 101 acquires a predetermined quantity of samples (referred to as “frames”) from the inputted digital data (S01). Although the predetermined quantity is 1024 in this embodiment, it may be larger or smaller than this number. The acquisition of samples is performed at a predetermined interval. The predetermined interval is, for example, 5 ms, but it may be longer or shorter than this duration.

In S02, the generating part 101 performs a thinning process. That is, the generating part 101 performs a 1/4 thinning on the 1024 samples to obtain 256 samples. The thinning may be one other than a 1/4 thinning. In S03, the generating part 101 performs fast Fourier transform (FFT) on the 256 samples, and obtains data (referred to as power data) indicating a magnitude of a power (spectral intensity) in frame units from the FFT result (power for each frequency bandwidth) (SO4). Since the power is represented by the square of amplitude, the concept of “power” also includes the amplitude.

The power data is, for example, a sum of the powers obtained by performing FFT on the 256 samples. However, the power of a corresponding bandwidth in a previous frame is subtracted from the power of each frequency bandwidth in a current frame, and if the value is positive (the power is increasing), the value of the power is retained for summation calculation; and the otherwise values (the subtracted value is negative (the power is decreasing)) may be ignored. This is because there is a high possibility that a position where the increase in power is large is the beat.

Further, as long as the target of comparison with other frames is the same, the value used to calculate the sum may be a sum of powers of the current frame, may be a sum of powers in which a value obtained by subtracting the power of the previous frame from the power of the current frame is a positive value, or may be a difference obtained by subtracting the power of the previous frame from the power of the current frame. Further, in the power spectrum obtained by performing the FFT, the calculation of difference described above may be performed only for frequencies lower than a predetermined frequency. A low-pass filter may be used to cut frequencies of the predetermined frequency or higher.

The power data is stored to the RAM 12 or the HDD 13 in frame units. Each time the power data in frame units is created, the generating part 101 compares magnitudes of the sums (peak values) of powers, retains the larger one, and discards the smaller one (S05). The generating part 101 determines whether a sum larger than the sum retained in S05 has not appeared for a predetermined duration (S06). The predetermined duration is, for example, 100 ms, but may also be longer or shorter than 100 ms. When a state in which a data indicating a larger sum has not appeared has continued for the predetermined duration, the generating part 101 extracts a data indicating the sum of powers (i.e., maximum peak in a time interval of the predetermined duration) as a Spx data and stores (saves) the data to the buffer 102 (S07). Therefore, the Spx data is a data obtained by extracting the peak value of a digital data representing a musical tone at an interval of 100 ms, and is a data representing information (timing information) indicating a timing governing a beat of a musical piece and a power at the timing. A plurality of Spx data are accumulated in the buffer 102. The generating part 101 repeats the processes from S01 to S06.

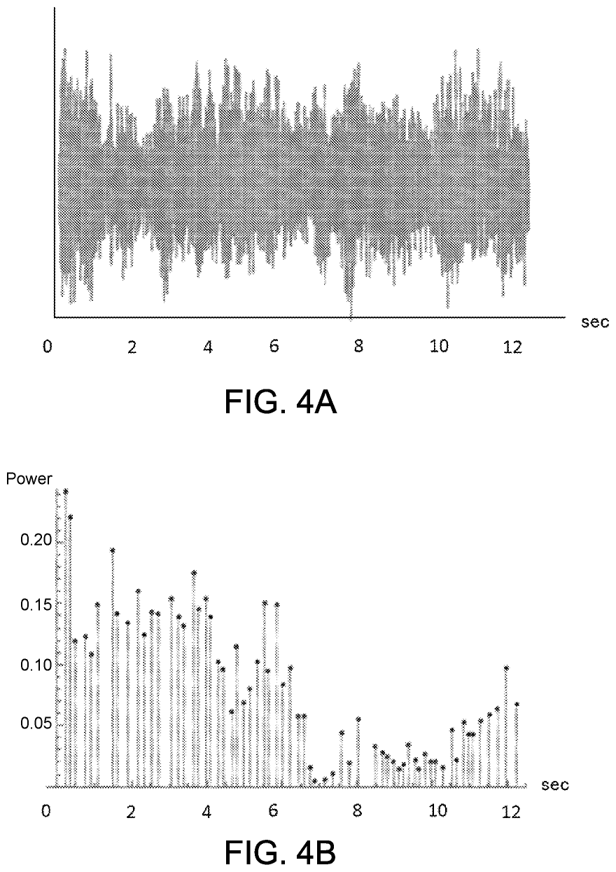

FIG. 4A shows a digital signal of a 12-second musical piece inputted to the generating part 101, and FIG. 4B shows an example of Spx data generated from the digital signal of the musical piece shown in FIG. 4A. The horizontal axis of the graph shown in FIG. 4B is time, and the vertical axis is power. In this graph, the vertical line with a black dot at the top shows individual Spx data obtained from the digital signal of the musical piece shown in FIG. 4A; the position on the horizontal axis (time axis) indicates timing; and the length of the vertical line indicates power. About 10 Spx data are generated per second in the case where they are generated at an interval of 100 ms.

<Calculation of Cycle Data and Phase Data>

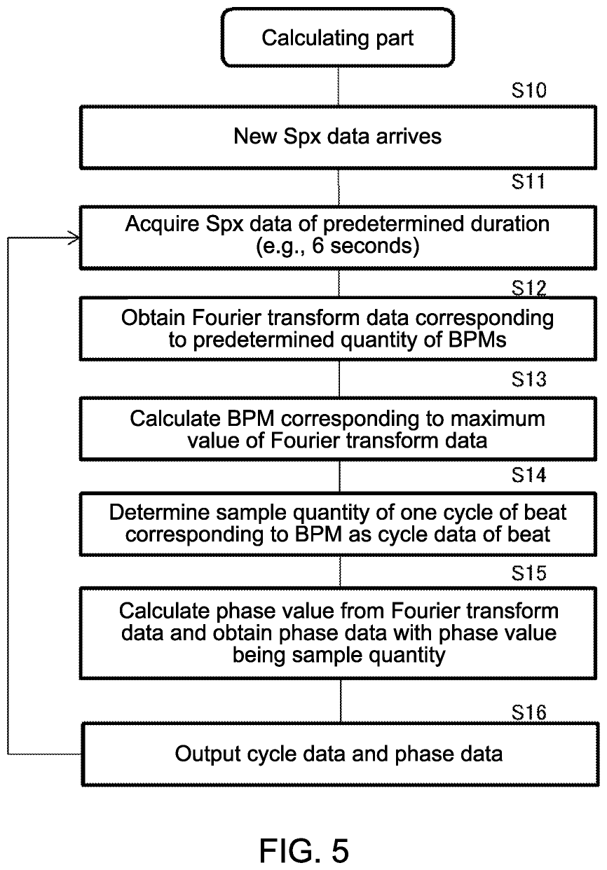

FIG. 5 is a flowchart showing a processing example of the calculating part 103. In S10, a new Spx data generated by the generating part 101 arrives at the buffer 102 and is accumulated. In S11, Spx data (corresponding to a plurality of intensity data) of a predetermined duration among the Spx data accumulated in the buffer 102 are acquired from the buffer 102. The predetermined duration is, for example, 6 seconds, but may be longer or shorter than 6 seconds as long as the cycle and the phase of the beat can be obtained. Subsequent processes of S12 to S16 are processes performed by using the Spx data of 6 seconds acquired in S11. In S12, Fourier transform corresponding to a predetermined quantity (e.g., 20) of BPMs (beats per minute: indicating tempo (speed of rhythm)) is performed on the Spx data of 6 seconds, and a cycle of the beat (one cycle of the BPM) and a phase of the beat (generation timing of the beat sound) are calculated.

Specifically, with the Spx data of 6 seconds, a sum of products with respect to Exp(2πjft) (sine wave oscillating at BPM frequency, amplitude being same regardless of oscillation frequency) is taken for a frequency (BPM frequency) f={86, 90, 94, . . . , 168}/60 corresponding to a predetermined quantity of BPMs in a predetermined BPM range, e.g., 20 BPMs corresponding to BPMs 86 to 168. That is, Fourier transform is performed. The result of the Fourier transform is taken as Fourier transform data c(i) (i=0, 1, 2, 3, . . . , 19).

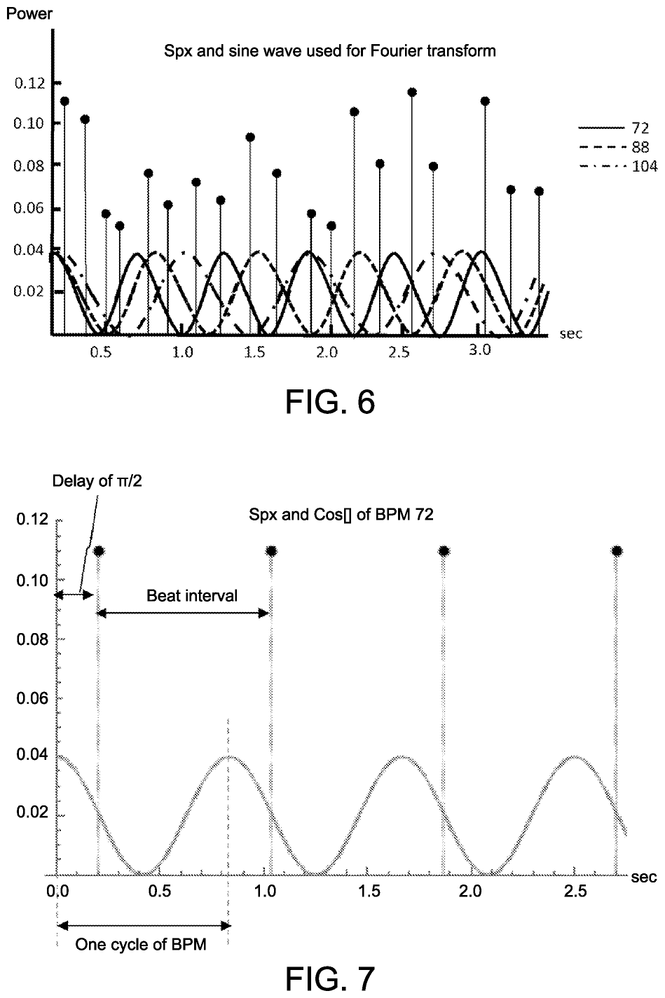

FIG. 6 is a diagram showing an example of Spx data and a sine wave having a BPM frequency used for Fourier transform. The example of FIG. 6 illustrates a sine wave of BPM 72 (indicated by a solid line), a sine wave of BPM 88 (indicated by a dashed line), and a sine wave of BPM 104 (indicated by a dot-dashed line). The value of the Fourier transform data c(i) is obtained according to Equation 1 below. The BPM values and the quantity thereof may be changed as appropriate.

$$\begin{matrix}[ Math . 1 ] & \\ c ( i ) = {\sum }_{k = 1}^{M} x ( t ( k ) ) Exp ( 2 π jf ( i ) t ( k ) ) & ( 1 )\end{matrix}$$

Herein, t(k) in Equation 1 is a time position within the past 6 seconds at which the Spx data is present, and the unit is seconds. k is an index of the Spx data, and k=1, . . . , M (M is the quantity of Spx data). Further, x(t(k)) indicates a value (magnitude of peak value) of the Spx data at that moment. j is an imaginary number unit (j²=−1). f(i) is the BPM frequency; for example, BPM 120 is 2.0 Hz.

Among c(i)=(c0, 1, c2, c3, . . . , c19), the calculating part 103 determines a BPM having an absolute value corresponding to a maximum value as the BPM of the Spx data (beat) (S13). Further, its phase value (Phase) ϕ=Arg(c(i))[rad] is set as the beat timing for the Spx data of 6 seconds. The beat timing indicates a relative position with respect to a generation timing of the beat which arrives periodically.

The phase value ϕ is an argument of a complex number, and is obtained according to Equation 2 below, in the case where c=cᵣₑ+jcᵢₘ (cᵣₑ is the real part and cᵢₘ is the imaginary part).

$$\begin{matrix}[ Math . 2 ] & \\ Arg ( c ( i ) ) = \{ \begin{matrix}Arc Tan ( \frac{{c}_{im}}{{c}_{re}} ) & {c}_{re} \geq 0 , {c}_{im} \geq 0 \\ Arc Tan ( \frac{{c}_{im}}{{c}_{re}} ) + π & {c}_{re} < 0 \\ Arc Tan ( \frac{{c}_{im}}{{c}_{re}} ) + 2 π & {c}_{re} \geq 0 , {c}_{im} < 0\end{matrix} & ( 2 )\end{matrix}$$

By calculating the phase value ϕ, it is possible to learn about the relative position of the generation timing of the beat with respect to the sine wave of the BPM, i.e., how much the beat generation timing is delayed with respect to one cycle of the BPM.

FIG. 7 illustrates a relationship between a cosine wave (real part of EXP(2πjft)) representing the BPM and generation timings of the beat. In the example shown in FIG. 7, the quantity of Spx data is 4 and the BPM thereof is 72. Each of the Spx data shown in FIG. 7 is the value (phase) of c(i) obtained using Equation 2, and indicates the generation timing of the beat. The interval between the Spx data forms an interval of the beat generation timings. In the example shown in FIG. 7, a timing delayed by π/2 from the cosine wave having the BPM frequency and obtained by calculating the phase value ϕ becomes the generation timing of the beat. The calculating part 103 takes a sample quantity of one cycle of the BPM as cycle data (S15).

For example, in the case where the BPM is 104 and the sampling rate is 44100 Hz, the cycle data (sample quantity) is 44100 [pieces]/(104/60)=25442 [pieces]. Further, in the case where the cycle data is 25442 [pieces], if the phase value ϕ is 0.34 [rad], the phase data (sample quantity) is 25442 [pieces]×0.34 [rad]/2π [rad]=1377 [pieces]. Then, the calculating part 103 outputs the cycle data and the phase data (S16). The calculating part 103 repeats the processes of S11 to S16 each time Spx data of 6 seconds are accumulated. Accordingly, it is possible to follow changes in the rhythm of the musical piece.

<Detection of Beat Generation Timing>

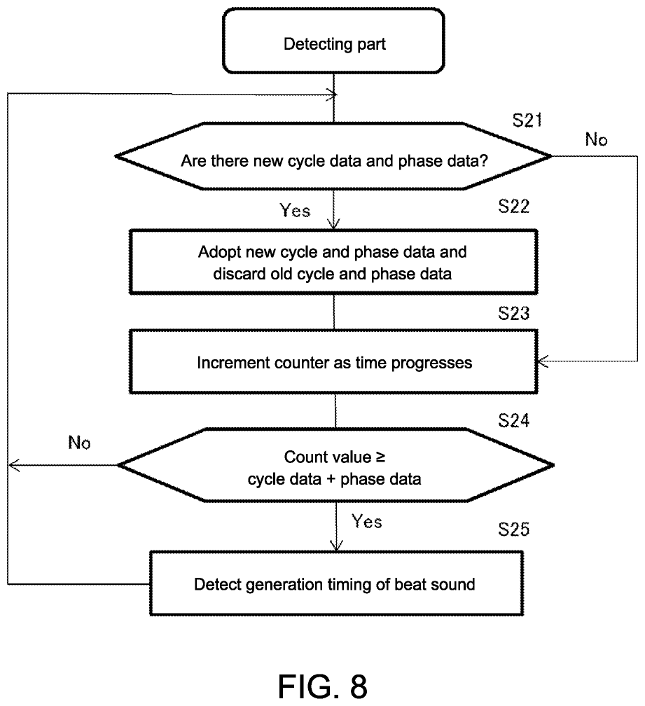

FIG. 8 is a flowchart showing an example of a detection process of a beat generation timing by the detecting part 104. In S21, the detecting part 104 determines whether new cycle data and phase data have been provided from the calculating part 103. If new cycle data and phase data have been provided, the process proceeds to S22; otherwise, the process proceeds to S23.

In S22, the detecting part 104 adopts the new cycle data and phase data for detection of the beat generation timing, and discards the old cycle data and phase data. At this time, at the time of creation of the Spx data, since a delay of 100 ms has been presented in the samples of the frames forming the Spx data, herein, time adjustment (phase adjustment) is performed so that the musical piece and rhythm being performed or reproduced and a handclap sound (to be described later) match each other. Afterwards, the process proceeds to S23.

In S23, a counter is set using the sample quantity of the cycle data and the sample quantity of the phase data. For example, the detecting part 104 includes a counter which counts up (increments) for each sample (interval between voltage checks of the analog signal according to the sampling rate) at the sampling rate, and increments a count value of the counter for each sample. Accordingly, the process waits until the count value increases from zero to a predetermined value (a value indicating a sum of the sample quantity (count value) of the phase data and the sample quantity (count value) of the cycle data) or more (S24).

When the count value of the counter reaches the predetermined value or more, the detecting part 104 detects a generation timing of the beat sound based on prediction, and outputs an output instruction of the beat sound (S25). In response to the output instruction, the reproduction processing part 105 sends a digital data of a beat sound (e.g., a handclap sound) pre-stored in the ROM 11 or the HDD 13 to the D/A 17. The digital data is converted into an analog signal by the D/A 17, amplified in amplitude by the AMP 18, and then outputted from the speaker 19. Accordingly, the handclap sound is outputted superimposed on the musical piece being reproduced or performed.

<Setting of BPM Range>

In the above example, with respect to a predetermined quantity (20) of BPMs selected from a predetermined BPM range (86 to 168), the BPM with a maximum absolute value of the Fourier transform value is determined as the BPM of the beat sound generation timing (steps S13 and S14 in FIG. 5). In the beat sound generation timing generating device 1 according to the embodiment, the BPM range may be changed in two stages, i.e., a “wide range” and a “narrow range” by an operation of the input device 14.

(First Method)

FIG. 11 is a flowchart showing a processing example showing a first method for setting the BPM range. The flow of FIG. 11 is performed by the CPU 10 executing a program. In step S101, the CPU 10 determines whether a command to change the BPM range has been inputted by an operation of the input device 14.

In step S101, if it is determined that a command to change the BPM range to a wide range has been inputted (the wide range has been specified), the CPU 10 sets the BPM range to the wide range (step S102). As an example of the wide range, the CPU 10 sets the minimum BPM value to 100 and sets the maximum BPM value to 240.

In contrast, if it is determined that a command to change the BPM range to a narrow range has been inputted (the narrow range has been specified), the CPU 10 sets the BPM range to the narrow range (step S103). As an example of the narrow range, the CPU 10 sets the minimum BPM value to 120 and sets the maximum BPM value to 160. If it is determined that there is no change, the CPU 10 does not perform any particular process, and the setting of the current BPM range is maintained. The minimum and maximum BPM values of each of the wide range and the narrow range are examples, and appropriate values may be set. This also applies to second and third methods to be described later.

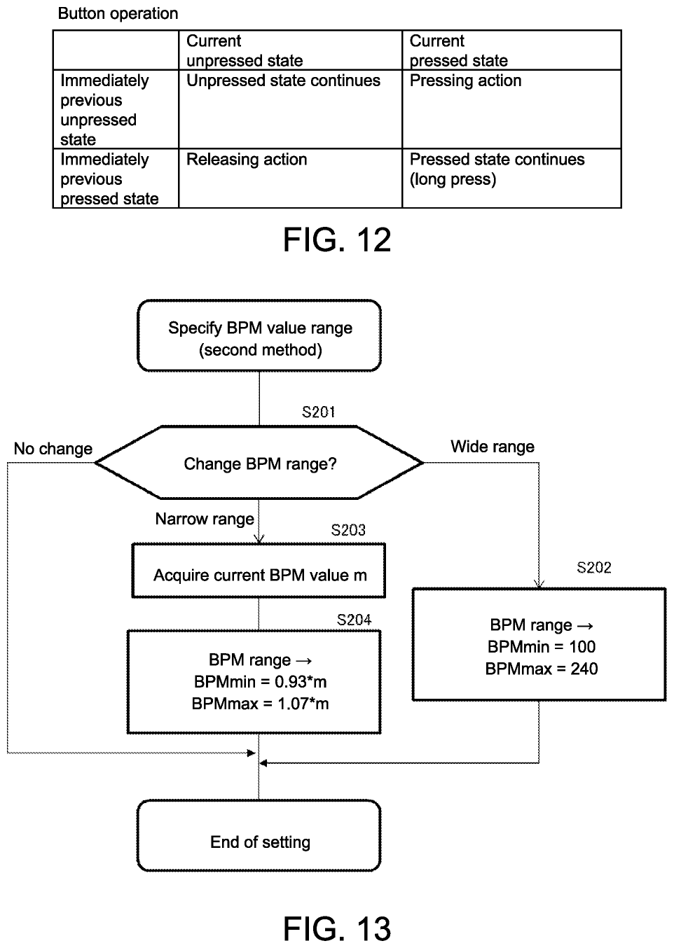

The process shown in FIG. 11 is performed by an operation of a button included in the input device 14, for example. That is, the CPU 10 periodically monitors the state of the button. FIG. 12 is a table showing states of the button. If the immediately previous state of the button is an unpressed state and the current state is also the unpressed state, as “no change”, the CPU 10 does not perform a process to change the BPM range. In contrast, if the button has been long pressed, i.e., if the pressed state continues at two or more state detection timings, the CPU 10 determines that the operation is an input of a change command, and performs a process to change the BPM range to the wide range (S101). Further, if press of the button has been released from a long press state, the CPU 10 determines that the operation is an input of a change command, and performs a process to change the BPM range to the narrow range.

In place of the configuration described above, the CPU 10 may change the BPM range each time the button is pressed. Also, in place of the button, a knob having ranges corresponding to two ranges, i.e., the wide range and the narrow range, may be used.

(Second Method)

FIG. 13 is a flowchart showing a processing example showing a second method for setting the BPM range. The flow of FIG. 13 is performed by the CPU 10 executing a program. In step S201, the CPU 10 determines whether a command to change the BPM range has been inputted by an operation of the input device 14.

In step S201, if it is determined that a command to change the BPM range to a wide range has been inputted (the wide range has been specified), as in step S102, the CPU 10 sets the BPM range to the wide range (step S202).

In contrast, if it is determined that a command to change the BPM range to a narrow range has been inputted (the narrow range has been specified), the CPU 10 acquires a current BPM value m and sets the BPM range to a range covering a predetermined percentage away from the value of m. In the example shown in FIG. 12, values 7% above and below the value of m are respectively set as the minimum and maximum BPM values. The predetermined percentage is, for example, 2 to 15%, and more preferably, 5 to 10%.

(Third Method)

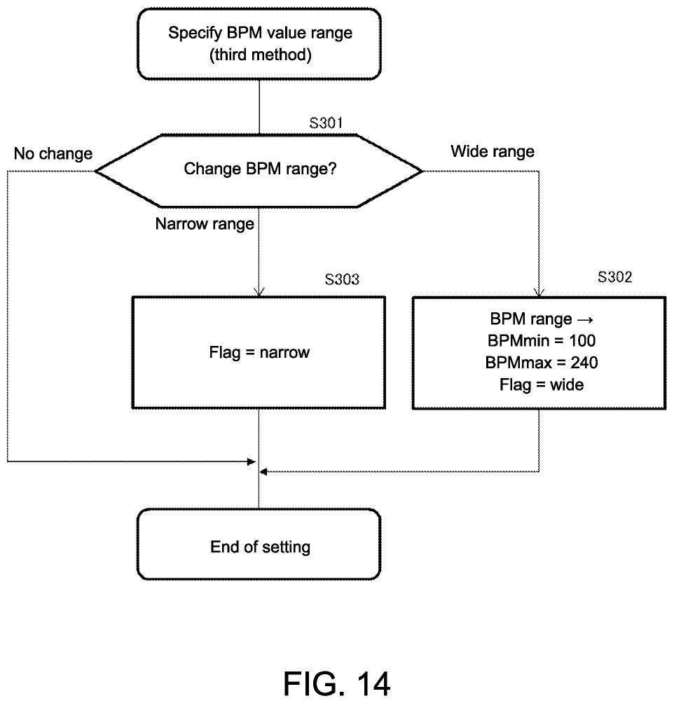

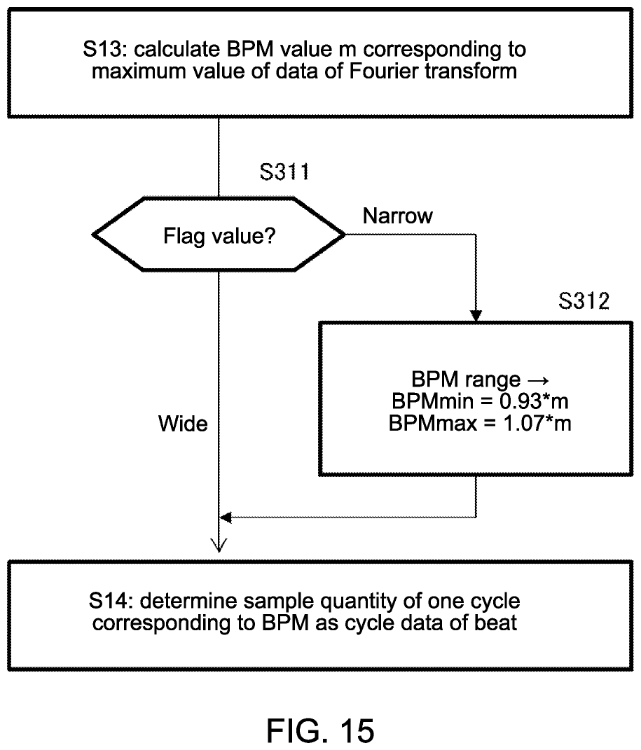

FIG. 14 and FIG. 15 are flowcharts showing a processing example showing a third method for setting the BPM range. The flows of FIG. 14 and FIG. 15 are performed by the CPU 10 executing a program. In step S301, the CPU 10 determines whether a command to change the BPM range has been inputted by an operation of the input device 14.

In step S301, if it is determined that a command to change the BPM range to a wide range has been inputted (the wide range has been specified), as in step S102, the CPU 10 sets the BPM range to the wide range. Further, the value of a flag indicating whether the range is wide or narrow is set to “wide” (value: 0 or 1) (step S302). In contrast, if it is determined that a command to change the BPM range to a narrow range has been inputted (the narrow range has been specified), the CPU 10 sets the value of the flag to “narrow” (value: 1 or 0) (step S303).

As shown in FIG. 15, in the third method, in step S13 of FIG. 5, a BPM value m corresponding to the maximum absolute value of the data of Fourier transform is calculated. In step S311, the CPU 10 checks the value of the flag, and if the value of the flag is “narrow”, as in step S202, the CPU 10 narrows the BPM range to a range of 7% above and below the BPM value m. Afterwards, the process proceeds to step S14. In contrast, if the value of the flag is “wide”, the process of step S14 is executed in the wide BPM range.

In each of S201 and S301 of the second and third methods, the CPU 10 does not perform any particular process in the case of “no change”. Further, the values of the BPM range, the maximum value, and the minimum value in the second and third methods may be arbitrary values as in the first method. Further, as the operation of the input device 14 related to the process of FIG. 12, the operation of the button or the knob described in the first method may be applied.

<Effects of Embodiments>

In the first to third methods related to the beat sound generation timing generating device 1 according to the embodiment, the BPM range is generally set to the “wide range”. Then, when generation (beat detection) of the generation timing of the beat sound is in progress, if more stable beat detection is desired, by operating the input device 14 (operator), the BPM range for detecting the beat is switched to the “narrow range”.

Generally, the intrinsic beat of a musical piece is 2/3 or 4/3 where it is an integer ratio. Accordingly, the “narrow range” is limited to a BPM range that is several percent to several tens of percent narrower than the wide range. Accordingly, by having one of two beats fall outside the BPM range for detecting the maximum BPM, the generation timing of the beat sound based on the corresponding beat is no longer generated. Accordingly, it is possible to constantly generate substantially regular generation timings of the beat sound.

In the second method, at the moment of an operation of the input device 14 (operator), e.g., when press of the button has been released from long press of the button (selection of “wide range”), the current BPM value is acquired, a range several percent above and below the acquired BPM value is set as the “narrow range”, and the BPM range for detecting the beat is switched to the “narrow range”.

When the user of the beat sound generation timing generating device 1 operates the operator, by performing an operation (e.g., releasing long press of the button) to select the moment at which the beat desired by the user is detected, a narrow range of the BPM including the BPM of the beat desired by the user can be set. Accordingly, the generation timing of the beat sound for the beat desired by the user can be generated, and generation timings of the beat sound that are constantly substantially regular without crossing are generated.

Furthermore, in the third method, the BPM value m is acquired at the moment of operation of the input device 14 (operator), and a range several percent above and below the BPM value m is set as the “narrow range”; while the “narrow range” (flag=narrow) is specified, a range several percent above and below the BPM value m that is detected immediately before is continuously set to the “narrow range”. Accordingly, it is possible to realize beat detection that follows changes in the musical piece in a natural manner while continuing stable beat detection.

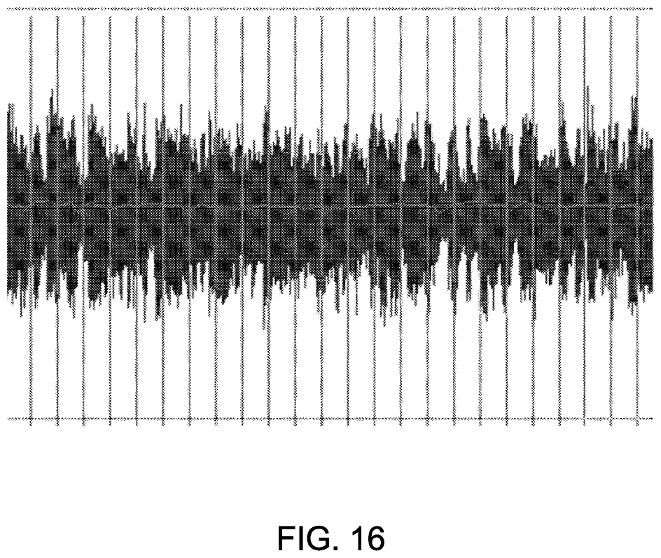

In FIG. 16, the vertical lines show the beats (generation timings of the beat sound) detected in the case where the second and third methods are applied to the signal of the musical piece shown in FIG. 9A, and it is understood that even though changes in the BPM occur as shown in 9B, the generation timing of the beat sound is stably generated (detected).

The process performed by the control part 100 may be performed by a plurality of CPUs (processors) or may be performed by a CPU having a multi-core configuration. Further, the process performed by the control part 100 may be implemented by a processor (DSP, GPU, etc.) other than the CPU 10, an integrated circuit (ASIC, FPGA, etc.) other than a processor, or a combination (MPU, SoC, etc.) of a processor and an integrated circuit.

### REFERENCE SIGNS LIST

1 . . . Beat sound generation timing generating device

2 . . . Network

10 . . . CPU

11 . . . ROM

12 . . . RAM

13 . . . HDD

14 . . . Input device

15 . . . Display device

16 . . . Communication interface

17 . . . Digital-to-analog converter

18 . . . Amplifier

19 . . . Speaker

20 . . . Analog-to-digital converter

21 . . . Microphone

100 . . . Control part

101 . . . Generating part

102 . . . Buffer

103 . . . Calculating part

104 . . . Detecting part

105 . . . Reproduction processing part

1. A beat sound generation timing generating device, comprising:
a generating part which generates, from inputted data of a musical piece, a plurality of intensity data in a predetermined time interval, each of the plurality of intensity data indicating a timing governing a beat of the musical piece and a power at the timing;
a calculating part which calculates a cycle and a phase of the beat of the musical piece by using the plurality of intensity data for each of the time intervals;
a detecting part which detects a generation timing of a beat sound based on the cycle and the phase of the beat of the musical piece; and
a control part which sets one of a wide range and a narrow range narrower than the wide range as a BPM (beats per minute) range to be used for calculation of the cycle and the phase of the beat for each of the time intervals.

2. The beat sound generation timing generating device according to claim 1, wherein
the BPM range being the narrow range is a predetermined numerical range centered on a BPM value to be used for calculation of the cycle and the phase of the beat in a current time interval.

3. The beat sound generation timing generating device according to claim 1, wherein
while a setting of selecting the narrow range is maintained, the calculating part performs calculation of the cycle and the phase of the beat for each of the time intervals by using the narrow range.

4. The beat sound generation timing generating device according to claim 1, wherein
while a button for switching the BPM range is long pressed, the control part sets the BPM range to the wide range, and in a case where long press of the button has been released, the control part changes the BPM range to the narrow range.

5. The beat sound generation timing generating device according to claim 1, wherein
the calculating part determines a BPM for the plurality of intensity data based on the timings indicated by the plurality of intensity data, calculates one cycle of the BPM as the cycle of the beat, and calculates, as the phase of the beat, a relative position of the generation timing of the beat sound in a sine wave representing the BPM, and
the detecting part obtains a count value indicating the cycle of the beat and the phase of the beat, performs timing of the count value by using a counter which increments for each sample at a sampling rate, and detects, as the generation timing of the beat sound, a timing at which a value of the counter reaches the count value.

6. The beat sound generation timing generating device according to claim 5, wherein
the calculating part calculates, as the cycle of the beat, one cycle of a BPM of a time when a value of Fourier transform data obtained by Fourier transform performed on each of the plurality of intensity data and each of a plurality of BPMs becomes maximum.

7. A beat sound generation timing generating method, comprising:
generating, by an information processing device from inputted data of a musical piece, a plurality of intensity data in a predetermined time interval, each of the plurality of intensity data indicating a timing governing a beat of the musical piece and a power at the timing;
calculating, by the information processing device, a cycle and a phase of the beat of the musical piece by using the plurality of intensity data for each of the time intervals;
detecting, by the information processing device, a generation timing of a beat sound based on the cycle and the phase of the beat of the musical piece; and
setting, by the information processing device, one of a wide range and a narrow range narrower than the wide range as a BPM (beats per minute) range to be used for calculation of the cycle and the phase of the beat for each of the time intervals.

8. The beat sound generation timing generating method according to claim 7, wherein
the BPM range being the narrow range is a predetermined numerical range centered on a BPM value to be used for calculation of the cycle and the phase of the beat in a current time interval.

9. The beat sound generation timing generating method according to claim 7, wherein
while a setting of selecting the narrow range is maintained, the information processing device performs calculation of the cycle and the phase of the beat for each of the time intervals by using the narrow range.

10. The beat sound generation timing generating method according to claim 7, wherein
while a button for switching the BPM range is long pressed, the information processing device sets the BPM range to the wide range, and in a case where long press of the button has been released, the information processing device changes the BPM range to the narrow range.

11. A non-transitory computer readable medium storing a program causing a computer to execute:
a generating process of generating, from inputted data of a musical piece, a plurality of intensity data in a predetermined time interval, each of the plurality of intensity data indicating a timing governing a beat of the musical piece and a power at the timing;
a calculating process of calculating a cycle and a phase of the beat of the musical piece by using the plurality of intensity data for each of the time intervals;
a detecting process of detecting a generation timing of a beat sound based on the cycle and the phase of the beat of the musical piece; and
a setting process of setting one of a wide range and a narrow range narrower than the wide range as a BPM (beats per minute) range to be used for calculation of the cycle and the phase of the beat for each of the time intervals.

12. The non-transitory computer readable medium according to claim 11, wherein
the BPM range being the narrow range is a predetermined numerical range centered on a BPM value to be used for calculation of the cycle and the phase of the beat in a current time interval.

13. The non-transitory computer readable medium according to claim 11, wherein
while a setting of selecting the narrow range is maintained, the calculating process performs calculation of the cycle and the phase of the beat for each of the time intervals by using the narrow range.

14. The non-transitory computer readable medium according to claim 11, wherein
while a button for switching the BPM range is long pressed, the setting process sets the BPM range to the wide range, and in a case where long press of the button has been released, the control part changes the BPM range to the narrow range.

15. The beat sound generation timing generating device according to claim 2, wherein
while a setting of selecting the narrow range is maintained, the calculating part performs calculation of the cycle and the phase of the beat for each of the time intervals by using the narrow range.

16. The beat sound generation timing generating device according to claim 2, wherein
while a button for switching the BPM range is long pressed, the control part sets the BPM range to the wide range, and in a case where long press of the button has been released, the control part changes the BPM range to the narrow range.

17. The beat sound generation timing generating device according to claim 3, wherein
while a button for switching the BPM range is long pressed, the control part sets the BPM range to the wide range, and in a case where long press of the button has been released, the control part changes the BPM range to the narrow range.

18. The beat sound generation timing generating method according to claim 8, wherein
while a setting of selecting the narrow range is maintained, the information processing device performs calculation of the cycle and the phase of the beat for each of the time intervals by using the narrow range.

19. The beat sound generation timing generating method according to claim 8, wherein
while a button for switching the BPM range is long pressed, the information processing device sets the BPM range to the wide range, and in a case where long press of the button has been released, the information processing device changes the BPM range to the narrow range.

20. The beat sound generation timing generating method according to claim 9, wherein
while a button for switching the BPM range is long pressed, the information processing device sets the BPM range to the wide range, and in a case where long press of the button has been released, the information processing device changes the BPM range to the narrow range.
